(19) United States
(12) Patent Application Publication
(10) Pub. No.: US 2025/0319732 A1
(43) Pub. Date: Oct. 16, 2025

(54) METHODS AND APPARATUS TO FACILITATE LOADING AND UNLOADING A VEHICLE

(71) Applicant: Ford Global Technologies, LLC, Dearborn, MI (US)

(72) Inventors: Elaine Grassel, Brighton, MI (US); Anthony Paul Magagnoli, Dexter, MI (US); Jonathan Michael Tucco, Livonia, MI (US); Dakota Drake Legge, South Lyon, MI (US); Soban Minhas, Windsor (CA); Emmanuel Gonzalez, Toluca (MX); Taylor Remington, Canton, MI (US); David Michael Russell, Ann Arbor, MI (US); Antonio Espiritu Santo, Atizapan de Zaragoza (MX); Emma Alvarez, Del. Gustavo A. Madero (MX)

(21) Appl. No.: 18/632,272

(22) Filed: Apr. 10, 2024

(51) Int. Cl. B60G 17/015

(52) U.S. Cl. CPC B60G 17/015; B60G 2500/324; B60G 2800/203; B60G 2800/914

(57) ABSTRACT

Methods and apparatus to facilitate loading and/or unloading a vehicle are disclosed. An example apparatus includes interface circuitry, machine readable instructions, and programmable circuitry to at least one of instantiate or execute the machine readable instructions to cause a suspension system to raise a front of a vehicle to a raised position, and cause the suspension system to lower a rear of the vehicle to a lowered position, the front in the raised position and the rear in the lowered position to slant the vehicle to facilitate loading or unloading the vehicle, and prevent the vehicle from having a driving speed or acceleration that satisfies a threshold when the rear is in the lowered position and the front is in the raised position.

### FIELD OF THE DISCLOSURE

This disclosure relates generally to vehicles and, more particularly, to methods and apparatus to facilitate loading and unloading a vehicle.

### BACKGROUND

Loading and unloading a vehicle (e.g., a bed of a truck, a trailer) is a difficult and labor intensive task. For example, a person may be required to move (e.g., lift, push, etc.) a load out of the bed of the truck, which can require significant time and/or effort, especially when the load is relatively large, heavy, and/or difficult to handle.

### SUMMARY

Example methods and apparatus to facilitate vehicle loading/unloading are disclosed. An example apparatus includes interface circuitry, machine readable instructions, and programmable circuitry to at least one of instantiate or execute the machine readable instructions to cause a suspension system to raise a front of a vehicle to a raised position, and cause the suspension system to lower a rear of the vehicle to a lowered position, the front in the raised position and the rear in the lowered position to slant the vehicle to facilitate loading or unloading the vehicle.

An example vehicle includes a suspension system including a front air compartment and a rear air compartment, the front air compartment coupled to a front portion of a body of the vehicle, and the rear air compartment coupled to a rear portion of the body of the vehicle, interface circuitry, machine readable instructions, and programmable circuitry to at least one of instantiate or execute the machine readable instructions to cause the suspension system to deliver air to the front air compartment to increase a height of the front portion of the vehicle to a first height, and cause the suspension system to remove air from the rear air compartment to decrease a height of the rear portion of the vehicle to a second height, the first height and the second height to slant the vehicle for unloading a bed of the vehicle, loading the bed of the vehicle, or coupling a trailer hitch of the vehicle to a towable body.

An example method includes causing a suspension system to position a front of a vehicle in a raised position, and causing the suspension system to position a rear of the vehicle in a lowered position, the front in the raised position and the rear in the lowered position to slant the vehicle to facilitate loading or unloading the vehicle.

### BRIEF DESCRIPTION OF THE DRAWINGS

FIG. 1 is a block diagram of an example vehicle in which example load adjustment control circuitry operates to facilitate loading and/or unloading the vehicle.

FIG. 2 illustrates example movement from an example driving position and an example unloading position associated with the vehicle of FIG. 1.

FIG. 3 illustrates example movement of an example trailer hitch of the vehicle of FIG. 1 to facilitate loading and/or unloading the vehicle.

FIG. 4 is a flowchart representative of example machine readable instructions and/or example operations that may be executed, instantiated, and/or performed by example programmable circuitry to implement the load adjustment control circuitry of FIG. 1.

FIG. 5 is another flowchart representative of example machine readable instructions and/or example operations that may be executed, instantiated, and/or performed by example programmable circuitry to implement the load adjustment control circuitry of FIG. 1.

FIG. 6 is another flowchart representative of example machine readable instructions and/or example operations that may be executed, instantiated, and/or performed by example programmable circuitry to implement the load adjustment control circuitry of FIG. 1.

FIG. 7 is a block diagram of an example processing platform including programmable circuitry structured to execute, instantiate, and/or perform the example machine readable instructions and/or perform the example operations of FIGS. 4, 5, and 6 to implement the load adjustment control circuitry of FIG. 1.

In general, the same reference numbers will be used throughout the drawing(s) and accompanying written description to refer to the same or like parts. The figures are not necessarily to scale.

### DETAILED DESCRIPTION

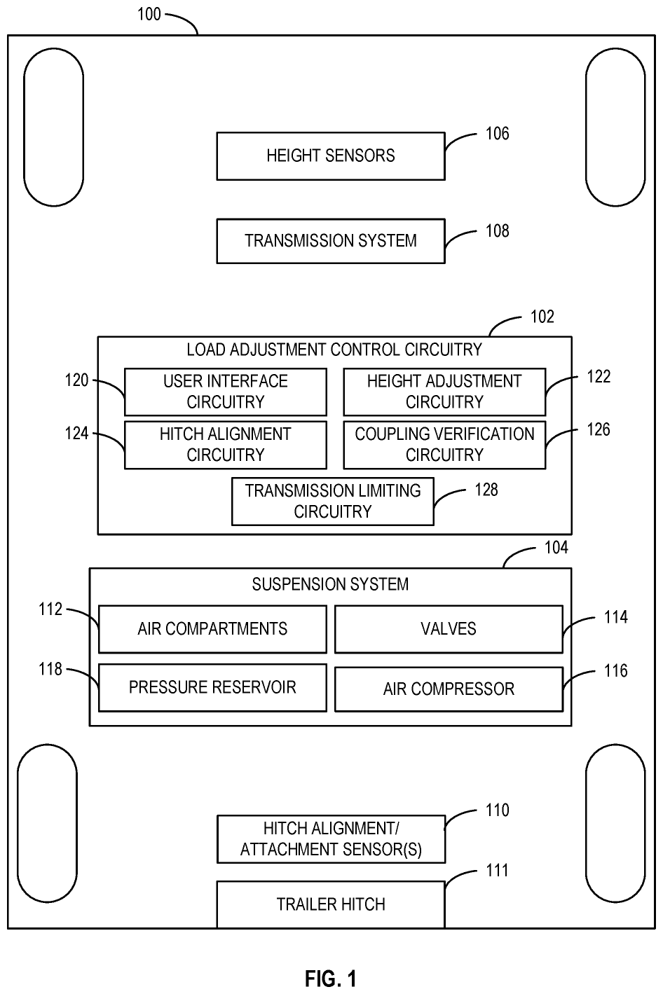

Examples disclosed herein facilitate loading and/or unloading a vehicle with reduced work from a user. Turning to the figures, FIG. 1 is a block diagram of an example vehicle 100 including load adjustment control circuitry 102 to facilitate loading and/or unloading the vehicle 100. The load adjustment control circuitry 102 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the load adjustment control circuitry 102 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the illustrated example of FIG. 1, the vehicle 100 includes a suspension system 104, height sensors 106, a transmission system 108, one or more hitch alignment sensor(s) 110 (e.g., an optical sensor(s), a camera(s)), and a trailer hitch 111 (e.g., a tow ball, a tow hook, a pintle, etc.). In the illustrated example of FIG. 1, the suspension system 104 is an air suspension system that includes air compartments 112 (e.g., airbags, air springs, etc.), valves 114, an air compressor 116, and a pressure reservoir 118. The air compartments 112 are positioned between a body (e.g., a frame, a chassis) of the vehicle 100 and another vehicle component, such as an axle or control arm, to support a weight of the vehicle 100 and enable adjustments to a ground clearance height (e.g., a ride height) of the vehicle 100. Specifically, the valves 114, the air compressor 116, and the pressure reservoir 118 can move air into the air compartments 112 to increase the ground clearance height or move air out of the air compartments 112 to reduce the ground clearance height. In some examples, the air compartments 112 include two compartments (e.g., a front air compartment and a rear air compartment) coupled to a front axle and a rear axle, respectively. In some examples, the air compartments 112 include four compartments associated with respective corners of the vehicle 100. Although the suspension system 104 of FIG. 1 is discussed in the context of an air suspension system, it should be understood that any other suspension system that enables a front height and a rear height of the vehicle 100 to be independently controlled can be utilized.

In the illustrated example of FIG. 1, the height sensors 106 the vehicle 100 detect a distance between the body of the vehicle 100 and a surface on which the vehicle 100 is located (e.g., a driving surface, a ground surface). The height sensors 106 can be coupled to the body of the vehicle 100 at or near wheels of the vehicle 100 and/or the axles of the vehicle 100. The height sensors 106 can detect a distance between (i) a mounting location to which the air compartments 112 couple to raise and lower the body of the vehicle 100 and (ii) a point on the surface beneath the vehicle 100. In some examples, the height sensors 106 are implemented by a potentiometer, a Hall effect sensor, an optical sensor, an ultrasonic sensor, or any other sensor capable of measuring the distance between the body of the vehicle 100 and the surface below the vehicle 100.

In the illustrated example of FIG. 1, the transmission system 108 controls power generated by an engine that is then transferred to wheels of the vehicle 100 to propel the vehicle 100. Accordingly, the transmission system 108 can include the engine, a gear system to operatively couple the engine to axles of the wheels, and/or associated programmable circuitry to control the output of the engine (e.g., a throttle position) and/or the shifting of gears in the gear system.

In the illustrated example of FIG. 1, the hitch alignment sensor(s) 110 enable the load adjustment control circuitry 102 to determine whether the trailer hitch 111 is aligned with a coupler (e.g., a hitch that corresponds with and is couplable to the trailer hitch 111) of a trailer to be towed by the vehicle 100. For example, the hitch alignment sensor(s) 110 can be one or more optical sensors operatively coupled to a rear portion of the vehicle 100 and that have a field of view that includes the trailer hitch 111 and/or a driving surface.

In the illustrated example of FIG. 1, the load adjustment control circuitry 102 is communicatively coupled to the suspension system 104. For example, the load adjustment control circuitry 102 can be communicatively coupled to the valves 114 and/or the air compressor 116 to control movement of air to and from the air compartments 112. Additionally, the load adjustment control circuitry 102 is communicatively coupled to the height sensors 106, the transmission system 108, and the hitch alignment sensor(s) 110.

In some examples, the load adjustment control circuitry 102 is an internal component of the vehicle 100. For example, the load adjustment control circuitry 102 can be implemented by a portion of an electronic control unit of the vehicle 100. In some examples, at least a portion of the load adjustment control circuitry 102 is implemented by a device that is external to and/or separable from the vehicle 100 and from/to which the suspension system 104, the height sensors 106, the transmission system 108, and/or the hitch alignment sensor(s) 110 can receive and/or transmit information. For example, the load adjustment control circuitry 102 can be implemented by an application on a user device, such as a smartphone and/or a tablet of a user associated with the vehicle 100.

In the illustrated example of FIG. 1, the load adjustment control circuitry 102 includes user interface circuitry 120 to facilitate communication with the user of the vehicle 100. For example, the user interface circuitry 120 can include and/or be communicatively coupled to a display with which the user can interact (e.g., a touchscreen), a speaker, a microphone, and/or any other component to enable communication between the user and the load adjustment control circuitry 102. In some examples, the user interface circuitry 120 prompts the user to select a particular operating mode according to which the vehicle 100 is to operate. For example, the user can activate and/or deactivate a loading mode, an unloading mode, a trailer coupling mode, and/or a trailer decoupling mode.

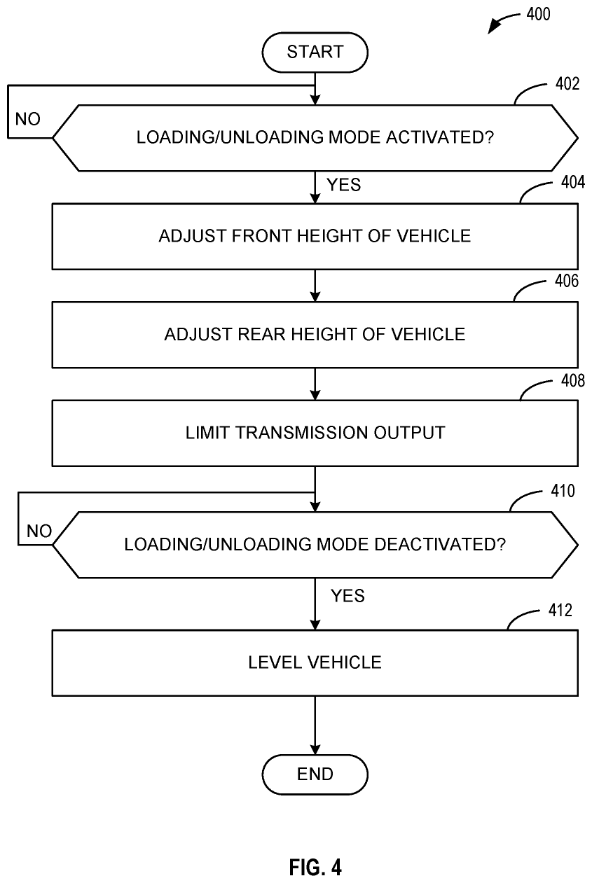

In some examples, the trailer coupling mode is an option within the loading mode. For example, when the user selects the loading mode, the user interface circuitry 120 can prompt the user to select between a truck bed loading mode (e.g., a first operating mode for loading material onto a bed of the vehicle 100) and the trailer coupling mode (e.g., a second operating mode for coupling a trailer to the trailer hitch 111). Similarly, in some examples, the trailer decoupling mode is an option within the unloading mode, which prompts the user to select between the trailer decoupling mode (e.g., a third operating mode for decoupling the trailer from the trailer hitch 111) and a truck bed unloading mode (e.g., a fourth operating mode for unloading material from the bed of the vehicle 100). In some examples, the user interface circuitry 120 provides another option within the trailer coupling mode for coupling weight distribution spring bars (e.g., spring bars) to the vehicle 100 and the trailer. In some such examples, the user interface circuitry 120 instructs the user to provide an input when the trailer hitch 111 is coupled to the trailer and the user is ready to attach the spring bars. In some examples, the user interface circuitry 120 renders instructions to the user pertinent to user actions to be performed in the selected operating mode. In some examples, the user interface circuitry 120 is instantiated by programmable circuitry executing user interface instructions and/or configured to perform operations such as those represented by the flowcharts of FIGS. 4, 5, and 6.

In the illustrated example of FIG. 1, the load adjustment control circuitry 102 includes height adjustment circuitry 122 to control adjustments to ground clearance heights (e.g., ride heights) of a front portion and/or a rear portion of the vehicle 100 when the vehicle 100 is operating in the loading mode or the unloading mode. For example, the height adjustment circuitry 122 can control the valves 114 and/or the air compressor 116 to cause air to move into or out of the air compartments 112 to adjust the ground clearance height(s) of the front portion and/or the rear portion. In some examples, the height adjustment circuitry 122 controls the suspension system 104 based on one or more heights measured by the height sensors 106. For example, the height adjustment circuitry 122 can compare the measured height(s) to one or more target height(s) to determine operations for the suspension system 104 to achieve the target height(s).

In the illustrated example of FIG. 1, when the vehicle 100 is operating in the truck bed unloading mode (e.g., when the user of the vehicle 100 selects the truck bed unloading mode), the height adjustment circuitry 122 causes the suspension system 104 to (i) raise a front portion of the body of the vehicle 100 to a first height (e.g., to a raised position) and (ii) lower a rear portion of the body of the vehicle 100 to a second height (e.g., to a lowered position, to a height less than the first height). In some examples, the first height is approximately a maximum ground clearance height associated with the vehicle 100, and the second height is approximately a minimum ground clearance height associated with the vehicle 100. As used herein, “approximately” a maximum ground clearance height associated with the vehicle 100 encompasses a maximum ground clearance height associated with the vehicle 100 (e.g., a maximum ground clearance height to which the body of the vehicle 100 can be raised by the suspension system 104, a maximum ground clearance height achievable by the suspension system 104) and more broadly encompasses a height within 15% of the maximum ground clearance height of the vehicle 100. Similarly, as used herein, “approximately” a minimum ground clearance height associated with the vehicle 100 encompasses a minimum ground clearance height associated with the vehicle 100 (e.g., a minimum ground clearance height to which the body of the vehicle 100 can be lowered by the suspension system 104, a minimum ground clearance height achievable by the air suspension system) and more broadly encompasses a height within 15% of the minimum ground clearance height of the vehicle 100. As a result, the height adjustment circuitry 122 slants (e.g., angles, inclines, etc.) the vehicle 100 to facilitate unloading material (e.g., from the bed of the vehicle 100). For example, when the bed of the vehicle 100 is slanted, a user can move an object or material towards and/or past a rear end of the bed of the vehicle 100 with less work and, thus, unload the object or material from the vehicle 100 more easily. In some examples, when the object is rollable (e.g., a ball, wheels, etc.), the object can roll from a front end of the bed past the rear end when the height adjustment circuitry 122 slants the bed.

In the illustrated example of FIG. 1, when the vehicle 100 is operating in the trailer coupling mode (e.g., when the user of the vehicle 100 selects the trailer coupling mode), the height adjustment circuitry 122 causes the suspension system 104 to lower the rear portion of the vehicle 100. For example, the height adjustment circuitry 122 can cause the valves 114 and/or the air compressor 116 to facilitate movement of air out of the air compartments 112 that support the rear portion of the vehicle 100. In some examples, the height adjustment circuitry 122 lowers the rear portion of the vehicle 100 to approximately the minimum height achievable by the suspension system 104. As a result, the height adjustment circuitry 122 moves the trailer hitch 111 to a position that minimizes or otherwise reduces a height to which a corresponding coupler (e.g., a socket) of a trailer is to be raised to enable the trailer hitch 111 to couple to the coupler from an underside thereof. In some examples, the height adjustment circuitry 122 also raises the front portion of the vehicle 100 to approximately the maximum height achievable by the suspension system 104.

The load adjustment control circuitry 102 determines whether the trailer hitch 111 is aligned with the coupler of the trailer, as discussed in further detail below. When the trailer hitch 111 is aligned with the coupler of the trailer, the height adjustment circuitry 122 causes the suspension system 104 to raise the rear portion of the vehicle 100 to cause the trailer hitch 111 to couple to the coupler of the trailer. For example, the height adjustment circuitry 122 can cause the suspension system 104 to raise the rear portion of the vehicle 100 to a same height as the front portion of the vehicle 100 (e.g., to approximately the maximum height associated with the vehicle 100). As a result, in some examples, the trailer hitch 111 couples to and lifts the coupler of the trailer as the rear portion of the vehicle 100 is raised. In some examples, the raised height of the rear portion of the vehicle 100 reduces a distance that the trailer would be cranked down (e.g., via a jack) to couple the coupler to the trailer hitch 111.

In some examples, when the rear portion of the vehicle 100 is raised to approximately the maximum height achievable by the suspension system 104, the hitch alignment sensor(s) 110 are able to obtain a better view of a parameter indicative of the trailer hitch 111 successfully coupling to the coupler. For example, causing the rear portion of the vehicle 100 to attain approximately the maximum height can enable the hitch alignment sensor(s) 110 to obtain better information associated with a position of a trailer jack relative to a driving surface (e.g., a ground surface). Thus, the load adjustment control circuitry 102 can more easily determine whether the trailer jack is lifted off the driving surface when the rear portion of the vehicle 100 is raised, which can be indicative of the trailer hitch 111 successfully lifting and coupling to the coupler, as discussed in further detail below.

In some examples, when the weight distribution spring bars are to be coupled to the trailer and the vehicle 100 to distribute the weight of the trailer and improve stability and control when towing, the height adjustment circuitry 122 causes the suspension system 104 to raise the rear of the vehicle 100. For example, the height adjustment circuitry 122 can cause the valves 114 and/or the air compressor 116 to facilitate movement of air into a portion of the air compartments 112 (e.g., the rear air compartment(s)). Specifically, the weight distribution spring bars are placed in tension to enable the weight distribution spring bars to provide trailer load distribution and benefits associated therewith. However, the weight distribution spring bars are not in tension when coupled to the trailer. So, height adjustment circuitry 122 causes the suspension system 104 to lower the rear of the vehicle 100 after the weight distribution bars are coupled to the vehicle 100 and the trailer, which applies tension to the weight distribution spring bars. As such, the load adjustment control circuitry 102 enables the user to couple the weight distribution spring bars to the trailer more easily and applies tension thereto.

In some examples, when the vehicle 100 is operating in the trailer decoupling mode (e.g., when the user of the vehicle 100 selects the trailer decoupling mode), the height adjustment circuitry 122 causes the suspension system 104 to lower the rear portion of the vehicle 100. For example, the height adjustment circuitry 122 can cause the valves 114 and/or the compressor 116 to move air out of the air compartments 112 coupled to the rear portion of the vehicle 100. Further, the trailer jack can be positioned such that the load of the trailer is transferred thereto in response to the rear portion of the vehicle 100 being lowered. As a result, the height adjustment circuitry 122 can cause the trailer hitch 111 to separate from (e.g., uncouple from, move out of engagement with) the coupler of the trailer. The vehicle 100 can then be moved such that the trailer hitch 111 is not aligned with the coupler before the height adjustment circuitry 122 causes the suspension system 104 to raise the rear portion of the vehicle 100 (e.g., cause the valves 114 and/or the compressor 116 to move air into the air compartments 112 coupled to the rear portion of the vehicle 100) to level the vehicle 100.

In some examples, when the vehicle 100 is operating in the trailer decoupling mode, the height adjustment circuitry 122 causes the suspension system 104 to raise the rear portion, and, optionally, the front portion, of the vehicle 100 in advance of lowering the rear portion. In such examples, raising the rear and/or front portion of the vehicle 100 in advance of lowering provides an increased ground clearance height between the trailer and the riding surface to enable the trailer jack to be positioned between the trailer and the driving surface more easily. As a result, the height adjustment circuitry 122 enables a trailer jack to be coupled to the trailer and positioned such that the load of the trailer on the trailer hitch 111 can be transferred to the trailer jack when the rear portion of the vehicle 100 is lowered (e.g., positioned vertically, positioned perpendicular to the trailer and/or the driving surface).

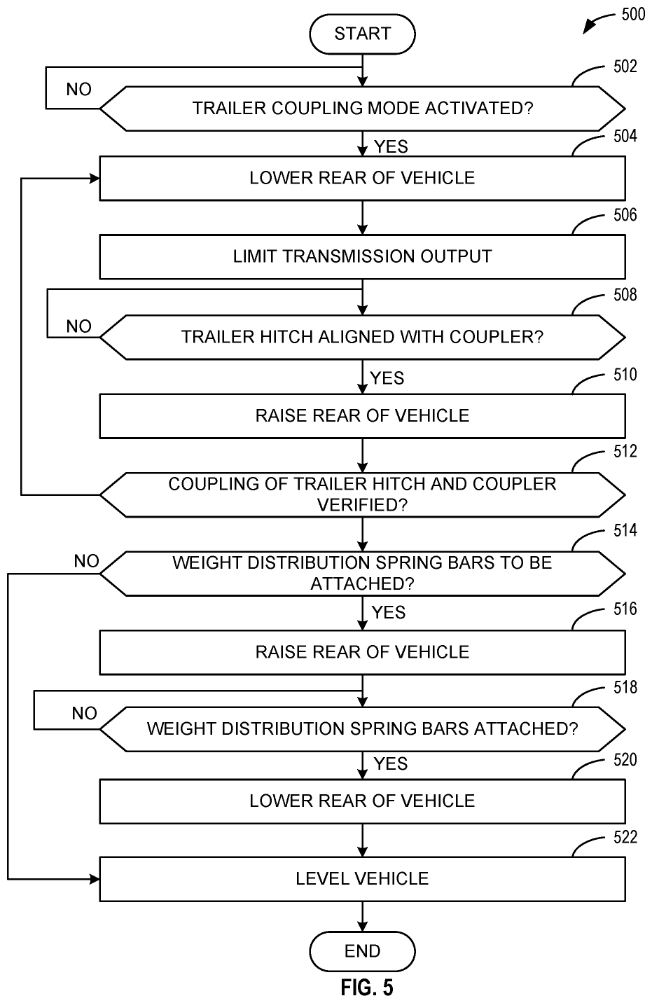

In the illustrated example of FIG. 1, when the vehicle 100 is operating in the truck bed loading mode, the height adjustment circuitry 122 causes the suspension system 104 to lower the body of the vehicle 100. For example, the height adjustment circuitry 122 can cause the suspension system 104 to lower the front and/or the rear portion of the body of the vehicle 100 to approximately the minimum ground clearance height associated with the vehicle 100 to reduce a height to which an object or material to be loaded is to be lifted to be placed on the vehicle 100 (e.g., on the bed of the vehicle 100. Thus, the height adjustment circuitry 122 can reduce the amount of work from the user to load the object or material on the vehicle 100. In some examples, the height adjustment circuitry 122 is instantiated by programmable circuitry executing height adjustment instructions and/or configured to perform operations such as those represented by the flowchart(s) of FIGS. 4, 5, and/or 6.

In the illustrated example of FIG. 1, the load adjustment control circuitry 102 includes hitch alignment circuitry 124 to determine whether the trailer hitch 111 is aligned with the coupler of the trailer external to the vehicle 100 when the vehicle 100 is operating in the trailer coupling mode. For example, the hitch alignment circuitry 124 can determine whether the trailer hitch 111 will couple to the coupler of the trailer when the height adjustment circuitry 122 causes the rear portion of the body of the vehicle 100 to be raised based on information obtained via the hitch alignment/attachment sensor(s) 110. In some examples, the hitch alignment circuitry 124 determines that the trailer hitch 111 is aligned with the coupler in response to the trailer hitch 111 and the coupler being in a predetermined positional relationship.

In some examples, when the front portion of the body of the vehicle 100 moves with the rear portion in the trailer coupling mode, the trailer hitch 111 is positioned directly under the coupler of the trailer in the predetermined positional relationship. In some examples, in the predetermined positional relationship, the hitch alignment circuitry 124 accounts for movement of the trailer hitch 111 in a rearward direction relative to the vehicle 100 as the suspension system 104 raises the rear portion of the body of the vehicle 100 while maintaining a ground clearance height of the front portion of the body of the vehicle 100 (e.g., at the approximately maximum height). The rearward movement can be vehicle dependent and predetermined based on, for example, a length of the vehicle 100, the maximum height associated with the vehicle 100, and the minimum height associated with the vehicle 100.

In some examples, the hitch alignment circuitry 124 determines whether the trailer hitch 111 is unaligned with the coupler of the trailer when the vehicle 100 is operating in the trailer decoupling mode. For example, after the height adjustment circuitry 122 has caused at least the rear portion of the body of the vehicle 100 to be lowered in the trailer decoupling mode, the hitch alignment circuitry 124 can determine whether the trailer hitch 111 will avoid contact with the trailer in response to being raised. In some examples, the hitch alignment circuitry 124 causes the user interface circuitry 120 to render an indicia of whether the trailer hitch 111 is unaligned with the trailer. For example, the indicia can change from red to green in response to the vehicle 100 moving the trailer hitch 111 out of alignment with the trailer. In some examples, the hitch alignment circuitry 124 is instantiated by programmable circuitry executing hitch alignment instructions and/or configured to perform operations such as those represented by the flowchart(s) of FIGS. 4, 5, and/or 6.

In the illustrated example of FIG. 1, the load adjustment control circuitry 102 includes coupling verification circuitry 126 to verify that the trailer hitch 111 is coupled to the coupler of the trailer when the vehicle 100 is operating in the trailer coupling mode. For example, the coupling verification circuitry 126 can determine whether the trailer hitch 111 is coupled to the trailer based on information from the hitch alignment/attachment sensor(s) 110. In some examples, the coupling verification circuitry 126 determines that the trailer hitch 111 is coupled to the trailer based on a position of the trailer hitch 111, a position of the coupler of the trailer, and/or a position of the trailer jack. For example, the coupling verification circuitry 126 can determine that the trailer hitch 111 is coupled to the trailer when the trailer jack is lifted off of the driving surface and the interlocked is positioned in and/or interlocked with the coupler after the rear portion of the body of the vehicle 100 is raised.

Additionally, the coupling verification circuitry 126 can verify that the trailer hitch 111 is uncoupled from the coupler of the trailer when the vehicle 100 is operating in the trailer decoupling mode. For example, the coupling verification circuitry 126 can determine that the trailer hitch 111 is uncoupled from the trailer when information from the hitch alignment/attachment sensor(s) 110 is indicative of the trailer hitch 111 being separated (e.g., spaced apart) from the coupler (e.g., by a vertical distance). In some examples, the coupling verification circuitry 126 determines whether the weight distribution spring bars are attached to the trailer and the trailer hitch 111 based on information from the hitch alignment/attachment sensor(s) 110. In some examples, the coupling verification circuitry 126 is instantiated by programmable circuitry executing coupling verification instructions and/or configured to perform operations such as those represented by the flowchart(s) of FIGS. 4, 5, and/or 6.

In the illustrated example of FIG. 1, the load adjustment control circuitry 102 includes transmission limiting circuitry 128 to limit an acceleration and/or a speed that the vehicle 100 can attain when the vehicle 100 is operating in the truck bed unloading mode, the truck bed loading mode, the trailer coupling mode, and/or the trailer decoupling mode. Thus, the transmission limiting circuitry 128 prevents the vehicle 100 from having a driving speed or acceleration that satisfies (e.g., is greater than, is greater than or equal to) a threshold (e.g., an acceleration threshold, a speed threshold). For example, the transmission limiting circuitry 128 can prevent a throttle of the transmission system 108 from moving past a certain position associated with a speed threshold and/or an acceleration threshold. In some examples, the transmission limiting circuitry 128 prevents the transmission system 108 from moving out of first gear.

In some examples, the speed threshold is 10 miles per hour (MPH). In such examples, enabling the vehicle 100 to accelerate to a degree can help facilitate movement of a load in the truck bed toward and/or past a rear end of the vehicle 100. Additionally or alternatively, enabling the vehicle 100 to accelerate to a degree can help the user align or misalign the trailer hitch 111 with the coupler of the trailer. In some other examples, the speed threshold is 0 MPH. In such examples, the transmission limiting circuitry 128 prevents the suspension system 104 from being affected by the vehicle 100 being driven while at least the rear portion of the vehicle 100 is at the approximately minimum height.

In some examples, the transmission limiting circuitry 128 implements a first speed and/or acceleration threshold in the truck bed loading and/or unloading modes and a second speed and/or acceleration threshold in the trailer coupling and/or decoupling mode. In some examples, the transmission limiting circuitry 128 triggers the height adjustment circuitry 122 to cause the suspension system 104 to level the vehicle 100 in response to the vehicle 100 driving at a speed or acceleration that satisfies the threshold. In some examples, the transmission limiting circuitry 128 is instantiated by programmable circuitry executing transmission limiting instructions and/or configured to perform operations such as those represented by the flowchart(s) of FIGS. 4, 5, and/or 6.

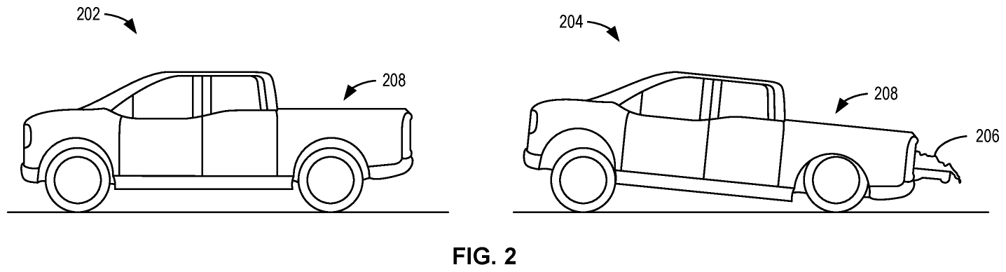

FIG. 2 illustrates an example transition of the vehicle 100 of FIG. 1 from a driving position 202 to an unloading position 204 to facilitate movement of a load 206 out of a truck bed 208 of the vehicle 100. In the illustrated example of FIG. 2, the height adjustment circuitry 122 moves the vehicle 100 from the driving position 202 to the unloading position 204 by causing the suspension system to (i) raise a front portion of the vehicle 100 to approximately the maximum height associated with the vehicle 100 and (ii) lower a rear portion of the vehicle 100 to approximately the minimum height associated with the vehicle 100.

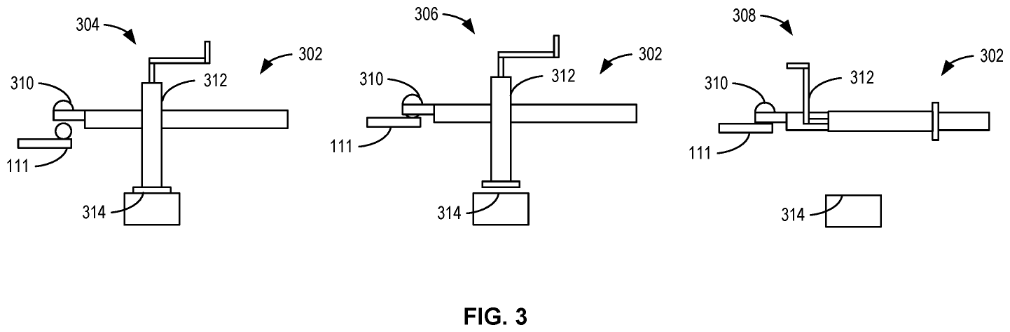

FIG. 3 illustrates example movement of the trailer hitch 111 of the vehicle 100 of FIG. 1 to facilitate loading and/or unloading the vehicle 100. Specifically, in the illustrated example of FIG. 3, the vehicle 100 and/or a trailer 302 (e.g., a utility trailer, an enclosed trailer, a flatbed trailer, a towable body, etc.) moves between an unattached position 304, an attached position 306, and a trailer jack stowed position 308. In the unattached position 304, the trailer hitch 111 is not coupled to (e.g., is separate from) a coupler 310 of the trailer 302. In some examples, the hitch alignment circuitry 124 determines whether the trailer hitch 111 is aligned with the coupler 310 in the unattached position 304. For example, the hitch alignment circuitry 124 can determine whether the trailer hitch 111 is aligned with the coupler 310 based on information from the hitch alignment/attachment sensor(s) 110.

In the illustrated example of FIG. 3, in the attached position 306, the trailer hitch 111 is coupled to the coupler 310. Specifically, the height adjustment circuitry 122 causes the suspension system 104 to raise the rear portion of the vehicle 100 and, in turn, the trailer hitch 111 after the hitch alignment circuitry 124 determines that the trailer hitch 111 is aligned with the coupler 310. In FIG. 3, the trailer hitch 111 is a ball hitch that is inserted into the coupler 310 in the attached position 306. However, it should be understood that the trailer hitch 111 can alternatively be implemented by another type of trailer hitch. In some examples, the coupling verification circuitry 126 confirms that the trailer hitch 111 is coupled to the coupler 310 when the trailer hitch 111 when a trailer jack 312 is lifted off of a driving surface 314 after the rear portion of the vehicle 100 is raised. Additionally or alternatively, the coupling verification circuitry 126 can verify that the trailer hitch 111 is coupled to the coupler 310 based on a position(s) of the trailer hitch 111 and/or the coupler 310. For example, the coupling verification circuitry 126 can determine whether the trailer jack 312 is lifted and/or identify a presence of the trailer hitch 111 outside of the coupler 310 based on information from the hitch alignment/attachment sensor(s) 110.

In the illustrated example of FIG. 3, after the coupling verification circuitry 126 confirms that the trailer 302 is coupled to the trailer hitch 111, the trailer jack 312 can be moved to a stowed position (e.g., a horizontal position). In some examples, the trailer jack 312 is decoupled from the trailer 302 after the coupling verification circuitry 126 confirms that the trailer 302 is coupled to the trailer hitch 111.

When the vehicle 100 is operating in the trailer unloading mode, the trailer jack 312 is moved out of the stowed position to the position shown in the attached position 306. The height adjustment circuitry 122 lowers at least the rear portion of the vehicle 100 to move the vehicle 100 to the unattached position 304. The coupling verification circuitry 126 verifies that the trailer hitch 111 is uncoupled from the coupler 310. The vehicle 100 can then move (e.g., forward) to move the trailer hitch 111 out of alignment with the coupler 310. After the vehicle 100 moves, the hitch alignment circuitry 124 verifies that the vehicle 100 will not contact the trailer 302 when the rear portion of the body of the vehicle 100 is raised. After the hitch alignment circuitry 124 verifies that the vehicle 100 will not contact the trailer 302, the height adjustment circuitry 122 can raise the rear portion of the vehicle 100 to a driving position.

While an example manner of implementing the load adjustment control circuitry 102 of FIG. 1 is illustrated in FIG. 1, one or more of the elements, processes, and/or devices illustrated in FIG. 1 may be combined, divided, re-arranged, omitted, eliminated, and/or implemented in any other way. Further, the example user interface circuitry 120, the example height adjustment circuitry 122, the example hitch alignment circuitry 124, the example coupling verification circuitry 126, the example transmission limiting circuitry 128, and/or, more generally, the example load adjustment control circuitry 102 of FIG. 1, may be implemented by hardware alone or by hardware in combination with software and/or firmware. Thus, for example, any of the example user interface circuitry 120, the example height adjustment circuitry 122, the example hitch alignment circuitry 124, the example coupling verification circuitry 126, the example transmission limiting circuitry 128, and/or, more generally, the example load adjustment control circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example load adjustment control circuitry 102 of FIG. 1 may include one or more elements, processes, and/or devices in addition to, or instead of, those illustrated in FIG. 1, and/or may include more than one of any or all of the illustrated elements, processes, and devices.

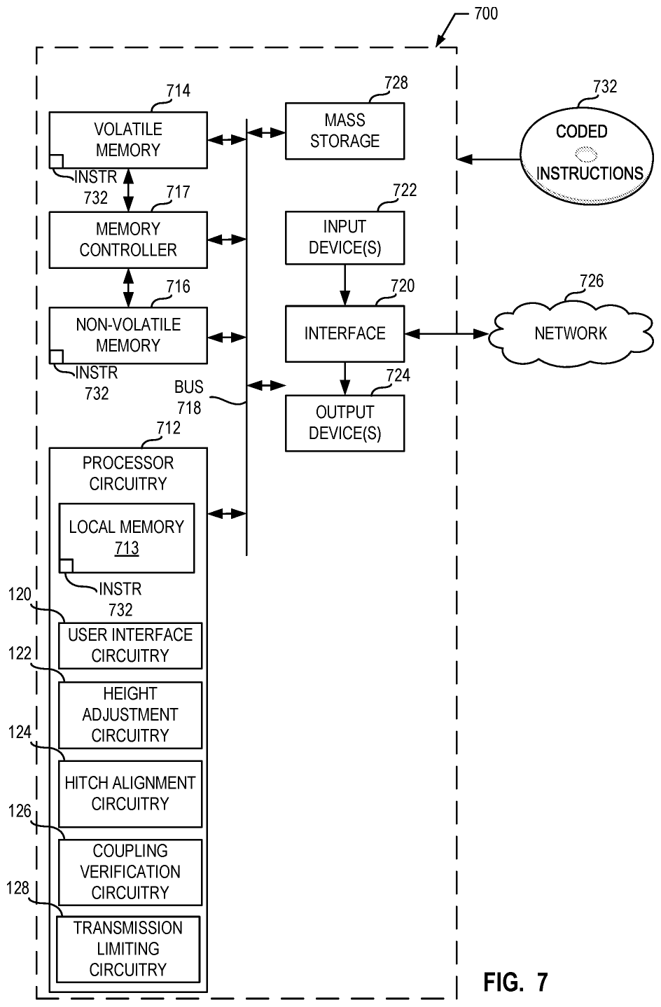

Flowcharts representative of example machine readable instructions, which may be executed by programmable circuitry to implement and/or instantiate the load adjustment control circuitry 102 of FIG. 1 and/or representative of example operations which may be performed by programmable circuitry to implement and/or instantiate the load adjustment control circuitry 102 of FIG. 1, are shown in FIGS. 4, 5, and 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4, 5, and 6, many other methods of implementing the example load adjustment control circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4, 5, and 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to facilitate loading and/or unloading the vehicle 100. The example machine-readable instructions and/or the example operations 400 of FIG. 4 begin at block 402, at which the load adjustment control circuitry 102 determines whether a loading mode or an unloading mode is activated. For example, the user interface circuitry 120 can determine whether the loading mode or the unloading mode is activated based on an input from a user associated with the vehicle 100. When the loading mode or the unloading mode is activated, the operations 400 proceed to block 404. Otherwise, when the loading mode or the unloading mode is not activated, the operations 400 repeat block 402.

At block 404, the load adjustment control circuitry 102 adjusts a front height of the vehicle 100. The height adjustment circuitry 122 can cause the suspension system 104 to adjust the ground clearance height of the front portion of the vehicle 100. In some example loading and/or unloading modes, the height adjustment circuitry raise the front of the vehicle 100 to approximately the maximum height associated with the vehicle 100. For example, the height adjustment circuitry 122 can cause the valves 114 and/or the air compressor 116 to facilitate movement of air into a first portion of the air compartments 112 (e.g., the front air compartment(s)). In some example loading modes, the height adjustment circuitry 122 causes the suspension system 104 to lower the front of the vehicle 100 to approximately the minimum height associated with the vehicle 100. For example, the height adjustment circuitry 122 can cause the valves 114 and/or the air compressor 116 to facilitate movement of air out of the first portion of the air compartments 112 (e.g., the front air compartment(s)).

At block 406, the load adjustment control circuitry 102 adjusts a rear height of the vehicle 100. For example, the height adjustment circuitry 122 can cause the suspension system to lower the rear of the vehicle 100 to approximately the minimum height associated with the vehicle 100. For example, the height adjustment circuitry 122 can cause the valves 114 and/or the air compressor 116 to facilitate movement of air out of a second portion of the air compartments 112 (e.g., the rear air compartment(s)).

At block 408, the load adjustment control circuitry 102 limits a transmission output of the vehicle 100. For example, the transmission limiting circuitry 128 can prevent the transmission system 108 from moving the vehicle 100 at a speed or acceleration that satisfies (e.g., is greater than, is greater than or equal to) a threshold when the front and rear of the vehicle 100 are in the respective adjusted positions.

At block 410, the load adjustment control circuitry 102 determines whether the loading or unloading mode is deactivated. For example, the user interface circuitry 120 can determine whether the loading or unloading mode is deactivated based on an input from a user associated with the vehicle 100.

At block 412, the load adjustment control circuitry 102 levels the vehicle 100. For example, the height adjustment circuitry 122 can cause the suspension system 104 to move the front and rear of the vehicle 100 to a same ground clearance height. In some examples, the height adjustment circuitry 122 causes the suspension system 104 to move the front and rear of the vehicle to the ground clearance height at which the vehicle 100 is to be driven.

FIG. 5 is a flowchart representative of example machine readable instructions and/or example operations 500 that may be executed, instantiated, and/or performed by programmable circuitry to attach the trailer 302 to the vehicle 100. The example machine-readable instructions and/or the example operations 500 of FIG. 5 begin at block 502, at which the load adjustment control circuitry 102 determines whether a trailer coupling mode (e.g., a trailer attachment mode) is activated. For example, the user interface circuitry 120 can determine whether the trailer coupling mode is activated based on an input from a user of the vehicle 100. When the trailer coupling mode is activated, the operations 500 proceed to block 504. Otherwise, when the trailer coupling mode is not activated, the operations 500 repeat block 502.

At block 504, the load adjustment control circuitry 102 lowers a rear of the vehicle 100. The height adjustment circuitry 122 can cause the suspension system 104 to lower the rear of the vehicle 100. For example, the height adjustment circuitry 122 can cause the valves 114 and/or the air compressor 116 to facilitate movement of air out of a portion of the air compartments 112 (e.g., the rear air compartment(s)). In some examples, the height adjustment circuitry 122 causes the suspension system 104 to lower the rear of the vehicle 100 to approximately the minimum height associated with the vehicle 100. In some examples, the height adjustment circuitry 122 also causes the suspension system 104 to lower the front of the vehicle 100 when the vehicle 100 is operating in the trailer coupling mode. For example, the height adjustment circuitry 122 can cause the valves 114 and/or the air compressor 116 to facilitate movement of air out of a portion of the air compartments 112 (e.g., the front air compartment(s)).

At block 506, the load adjustment control circuitry 102 limits a transmission output of the vehicle 100. For example, the transmission limiting circuitry 128 can prevent the transmission system 108 from moving the vehicle 100 at a speed or acceleration that satisfies (e.g., is greater than, is greater than or equal to) a threshold when the front and rear of the vehicle 100 are in the respective adjusted positions. As a result, the transmission limiting circuitry 128 can help the user align the trailer hitch 111 with the coupler 310 by reducing a magnitude of movements encountered by the vehicle 100 when the user presses an accelerator of the transmission system 108.

At block 508, the load adjustment control circuitry 102 determines whether the trailer hitch 111 is aligned with the coupler 310 of the trailer 302. For example, the hitch alignment circuitry 124 can determine whether the trailer hitch 111 is aligned with the coupler 310 based on information from the hitch alignment/attachment sensor(s) 110. When the trailer hitch 111 is aligned with the coupler 310, the operations 500 proceed to block 510. Otherwise, when the trailer hitch 111 is not aligned with the coupler 310, the operations 500 repeat block 508.

At block 510, the load adjustment control circuitry 102 raises the rear of the vehicle 100. The height adjustment circuitry 122 can cause the suspension system 104 to raise the rear of the vehicle 100. For example, the height adjustment circuitry 122 can cause the valves 114 and/or the air compressor 116 to facilitate movement of air into a portion of the air compartments 112 (e.g., the rear air compartment(s)). As a result, the trailer hitch 111 can contact and couple to the coupler 310 of the trailer 302.

At block 512, the load adjustment control circuitry 102 determines whether a coupling of the trailer hitch 111 and the coupler 310 is verified. For example, the coupling verification circuitry 126 can verify that the trailer hitch 111 is coupled to the coupler 310 of the trailer 302 based on information from the hitch alignment/attachment sensor(s) 110. When the coupling is verified, the operations 500 proceed to block 514. Otherwise, when the coupling is not verified, the operations 500 return to block 504.

At block 514, the load adjustment control circuitry 102 determines whether weight distribution spring bars (e.g., spring bars) are to be attached. For example, the user interface circuitry 120 can identify that the weight distribution spring bars are to be attached to the trailer hitch 111 and the trailer based on an input from a user of the vehicle 100. When the weight distribution spring bars are to be attached, the operations 500 proceed to block 516. Otherwise, the operations 500 skip to block 522.

At block 516, the load adjustment control circuitry 102 raises the rear of the vehicle 100. The height adjustment circuitry 122 can cause the suspension system 104 to raise the rear of the vehicle 100. For example, the height adjustment circuitry 122 can cause the valves 114 and/or the air compressor 116 to facilitate movement of air into a portion of the air compartments 112 (e.g., the rear air compartment(s)). As such, the load adjustment control circuitry 102 enables the user to couple the weight distribution spring bars to the trailer more easily and in a position that will cause the weight distribution spring bars to be in tension when the rear of the vehicle 100 is lowered. In some examples, the height adjustment circuitry 122 to an approximately maximum height associated with the vehicle 100.

At block 518, the load adjustment control circuitry 102 determines whether the weight distribution spring bars are attached. For example, the coupling verification circuitry 126 can determine whether the weight distribution spring bars are attached to the trailer and the trailer hitch 111 based on information from the hitch alignment/attachment sensor(s) 110. In some examples, the coupling verification circuitry 126 identifies that the weight distribution spring bars are attached based on an input received via the user interface circuitry 120. When the weight distribution spring bars are attached, the operations 500 proceed to block 520. Otherwise, when the weight distribution spring bars are not attached, the operations 500 repeat block 518.

At block 520, the load adjustment control circuitry 102 lowers the rear of the vehicle 100. The height adjustment circuitry 122 can cause the suspension system 104 to lower the rear of the vehicle 100. For example, the height adjustment circuitry 122 can cause the valves 114 and/or the air compressor 116 to facilitate movement of air out of a portion of the air compartments 112 (e.g., the rear air compartment(s)). In some examples, the height adjustment circuitry 122 lowers the rear of the vehicle 100 to a ground clearance height at which the vehicle 100 is to be driven.

At block 522, the load adjustment control circuitry 102 levels the vehicle 100. For example, if the vehicle 100 is not already level, the height adjustment circuitry 122 can cause the suspension system 104 to move the front and rear of the vehicle 100 to a same ground clearance height. In some examples, the height adjustment circuitry 122 causes the suspension system 104 to move the front and rear of the vehicle to the ground clearance height at which the vehicle 100 is to be driven.

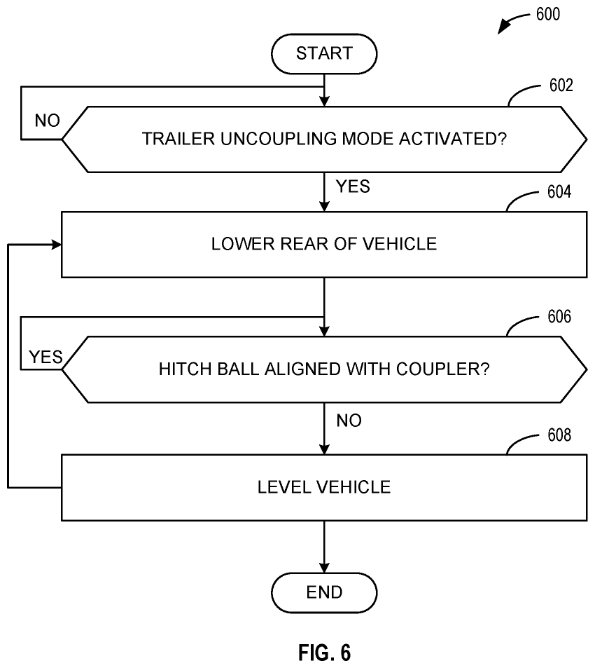

FIG. 6 is a flowchart representative of example machine readable instructions and/or example operations 600 that may be executed, instantiated, and/or performed by programmable circuitry to detach the trailer 302 from the vehicle 100. The example machine-readable instructions and/or the example operations 600 of FIG. 6 begin at block 602, at which the load adjustment control circuitry 102 determines whether a trailer uncoupling mode (e.g., a trailer detachment mode) is activated. For example, the user interface circuitry 120 can determine whether the trailer uncoupling mode is activated based on an input from a user of the vehicle 100. When the trailer uncoupling mode is activated, the operations 600 proceed to block 604. Otherwise, when the trailer coupling mode is not activated, the operations 600 repeat block 602.

At block 604, the load adjustment control circuitry 102 lowers a rear of the vehicle 100. The height adjustment circuitry 122 can cause the suspension system 104 to lower the rear of the vehicle 100. For example, the height adjustment circuitry 122 can cause the valves 114 and/or the air compressor 116 to facilitate movement of air out of a portion of the air compartments 112 (e.g., the rear air compartment(s)). In some examples, the height adjustment circuitry 122 causes the suspension system 104 to lower the rear of the vehicle 100 to approximately the minimum height associated with the vehicle 100.

At block 606, the load adjustment control circuitry 102 determines whether the trailer hitch 111 is aligned with the coupler 310 of the trailer 302. For example, the hitch alignment circuitry 124 can determine whether the trailer hitch 111 is aligned with the coupler 310 based on information from the hitch alignment/attachment sensor(s) 110. When the trailer hitch 111 is not aligned with the coupler 310, the operations 600 proceed to block 608. Otherwise, when the trailer hitch 111 is aligned with the coupler 310, the operations 600 repeat block 606.

At block 608, the load adjustment control circuitry 102 levels the vehicle 100. For example, the height adjustment circuitry 122 can cause the suspension system 104 to move the rear of the vehicle 100 to a same ground clearance height as a front of the vehicle 100. In some examples, the height adjustment circuitry 122 causes the suspension system 104 to move the front and rear of the vehicle to the ground clearance height at which the vehicle 100 is to be driven.

FIG. 7 is a block diagram of an example programmable circuitry platform 700 structured to execute and/or instantiate the example machine-readable instructions and/or the example operations of FIGS. 4, 5, and 6 to implement the load adjustment control circuitry 102 of FIG. 1. The programmable circuitry platform 700 can be, for example, a mobile device (e.g., a cell phone, a smart phone, a tablet such as an iPad™), an Internet appliance, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the user interface circuitry 120, the height adjustment circuitry 122, the hitch alignment circuitry 124, the coupling verification circuitry 126, and the transmission limiting circuitry 128.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a button, and/or a touchscreen.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or speaker. In some examples, the input device(s) 722 and/or the output device(s) 724 implement at least a portion of the user interface circuitry 120. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 4, 5, and 6, may be stored in the mass storage device 728, in the volatile memory 714, in the non-volatile memory 716, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that facilitate loading and/or unloading a vehicle.

Further examples and combinations thereof include the following:

Example 1 includes an apparatus comprising interface circuitry, machine readable instructions, and programmable circuitry to at least one of instantiate or execute the machine readable instructions to cause a suspension system to raise a front of a vehicle to a raised position, cause the suspension system to lower a rear of the vehicle to a lowered position, the front in the raised position and the rear in the lowered position to slant the vehicle to facilitate loading or unloading the vehicle, and prevent the vehicle from having a driving speed or acceleration that satisfies a threshold when the rear is in the lowered position and the front is in the raised position.

Example 2 includes the apparatus of example 1, wherein the threshold is a driving speed of 0 miles per hour.

Example 3 includes the apparatus of example 1, wherein the threshold is a driving speed of 10 miles per hour.

Example 4 includes the apparatus of example 1, wherein the programmable circuitry is to at least one of instantiate or execute the machine readable instructions to cause the suspension system to level the vehicle in response to the vehicle driving at the driving speed or acceleration that satisfies the threshold.

Example 5 includes the apparatus of example 1, wherein the raised position corresponds with approximately a maximum height associated with the suspension system, and wherein the lowered position corresponds with approximately a minimum height associated with the suspension system.

Example 6 includes the apparatus of example 1, wherein the programmable circuitry is to at least one of instantiate or execute the machine readable instructions to determine whether a trailer hitch of the vehicle is aligned with a coupler external to the vehicle, and when the trailer hitch is aligned with the coupler, cause the suspension system to raise the rear of the vehicle.

Example 7 includes the apparatus of example 6, wherein the programmable circuitry is to at least one of instantiate or execute the machine readable instructions to determine whether the trailer hitch is coupled to the coupler based on a position of a trailer jack connected to the trailer hitch.

Example 8 includes the apparatus of example 7, wherein the programmable circuitry is to at least one of instantiate or execute the machine readable instructions to cause the suspension system to level the vehicle in response to determining that the trailer hitch is coupled to the coupler, and cause the suspension system to lower the rear of the vehicle in response to determining that the trailer hitch is not coupled to the coupler.

Example 9 includes a vehicle comprising a suspension system including a front air compartment and a rear air compartment, the front air compartment coupled to a front portion of a body of the vehicle, and the rear air compartment coupled to a rear portion of the body of the vehicle, interface circuitry, machine readable instructions, and programmable circuitry to at least one of instantiate or execute the machine readable instructions to cause the suspension system to deliver air to the front air compartment to increase a height of the front portion of the vehicle to a first height, cause the suspension system to remove air from the rear air compartment to decrease a height of the rear portion of the vehicle to a second height, the first height and the second height to slant the vehicle for unloading a bed of the vehicle, loading the bed of the vehicle, or coupling a trailer hitch of the vehicle to a towable body, and prevent the vehicle from driving at a speed that satisfies a threshold when the front portion of the vehicle has the first height and the rear portion of the vehicle has the second height.

Example 10 includes the vehicle of example 9, wherein the threshold is 0 miles per hour.

Example 11 includes the vehicle of example 9, wherein the threshold is 10 miles per hour.

Example 12 includes the vehicle of example 9, wherein the programmable circuitry is to at least one of instantiate or execute the machine readable instructions to determine whether the trailer hitch of the vehicle is aligned with a portion of the towable body to which the trailer hitch is couplable, and after the trailer hitch is aligned with the portion of the towable body, cause the suspension system to deliver air to the rear air compartment to raise the rear portion of the vehicle.

Example 13 includes the vehicle of example 12, wherein the programmable circuitry is to at least one of instantiate or execute the machine readable instructions to determine that the trailer hitch is coupled to the portion of the towable body when a trailer jack connected to the towable body is raised off a surface after the suspension system delivers air to the rear air compartment.

Example 14 includes the vehicle of example 13, wherein the programmable circuitry is to at least one of instantiate or execute the machine readable instructions to cause the suspension system to level the vehicle in response to determining that the trailer hitch is coupled to the portion of the towable body, and cause the suspension system to remove air from the rear air compartment to lower the rear portion of the vehicle in response to determining that the trailer hitch is not coupled to the portion of the towable body.

Example 15 includes a method comprising causing a suspension system to position a front of a vehicle in a raised position, causing the suspension system to position a rear of the vehicle in a lowered position, the front in the raised position and the rear in the lowered position to slant the vehicle to facilitate loading or unloading the vehicle, and preventing the vehicle from driving at a speed that satisfies a threshold when the front is in the raised position and the rear is in the lowered position.

Example 16 includes the method of example 15, wherein the threshold is 0 miles per hour.

Example 17 includes the method of example 15, wherein the threshold is 10 miles per hour.

Example 18 includes the method of example 15, wherein the raised position corresponds with approximately a maximum height associated with the suspension system, and wherein the lowered position corresponds with approximately a minimum height associated with the suspension system.

Example 19 includes the method of example 15, further including causing the suspension system to level the vehicle in response to the vehicle driving at the speed or that satisfies the threshold.

Example 20 includes the method of example 15, further including determining whether a trailer hitch of the vehicle is aligned with a coupler external to the vehicle, and when the trailer hitch is aligned with the coupler, causing the suspension system to raise the rear of the vehicle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
cause a suspension system to raise a front of a vehicle to a raised position;
cause the suspension system to lower a rear of the vehicle to a lowered position, the front in the raised position and the rear in the lowered position to slant the vehicle to facilitate loading or unloading the vehicle; and
prevent the vehicle from having a driving speed or acceleration that satisfies a threshold when the rear is in the lowered position and the front is in the raised position.

2. The apparatus of claim 1, wherein the threshold is a driving speed of 0 miles per hour.

3. The apparatus of claim 1, wherein the threshold is a driving speed of 10 miles per hour.

4. The apparatus of claim 1, wherein the programmable circuitry is to at least one of instantiate or execute the machine readable instructions to cause the suspension system to level the vehicle in response to the vehicle driving at the driving speed or acceleration that satisfies the threshold.

5. The apparatus of claim 1, wherein the raised position corresponds with approximately a maximum height associated with the suspension system, and wherein the lowered position corresponds with approximately a minimum height associated with the suspension system.

6. The apparatus of claim 1, wherein the programmable circuitry is to at least one of instantiate or execute the machine readable instructions to:
determine whether a trailer hitch of the vehicle is aligned with a coupler external to the vehicle; and
when the trailer hitch is aligned with the coupler, cause the suspension system to raise the rear of the vehicle.

7. The apparatus of claim 6, wherein the programmable circuitry is to at least one of instantiate or execute the machine readable instructions to determine whether the trailer hitch is coupled to the coupler based on a position of a trailer jack connected to the trailer hitch.

8. The apparatus of claim 7, wherein the programmable circuitry is to at least one of instantiate or execute the machine readable instructions to:
cause the suspension system to level the vehicle in response to determining that the trailer hitch is coupled to the coupler; and
cause the suspension system to lower the rear of the vehicle in response to determining that the trailer hitch is not coupled to the coupler.

9. A vehicle comprising:
a suspension system including a front air compartment and a rear air compartment, the front air compartment coupled to a front portion of a body of the vehicle, and the rear air compartment coupled to a rear portion of the body of the vehicle;
interface circuitry;
machine readable instructions; and
programmable circuitry to at least one of instantiate or execute the machine readable instructions to:
cause the suspension system to deliver air to the front air compartment to increase a height of the front portion of the vehicle to a first height;
cause the suspension system to remove air from the rear air compartment to decrease a height of the rear portion of the vehicle to a second height, the first height and the second height to slant the vehicle for unloading a bed of the vehicle, loading the bed of the vehicle, or coupling a trailer hitch of the vehicle to a towable body; and
prevent the vehicle from driving at a speed that satisfies a threshold when the front portion of the vehicle has the first height and the rear portion of the vehicle has the second height.

10. The vehicle of claim 9, wherein the threshold is 0 miles per hour.

11. The vehicle of claim 9, wherein the threshold is 10 miles per hour.

12. The vehicle of claim 9, wherein the programmable circuitry is to at least one of instantiate or execute the machine readable instructions to:
determine whether the trailer hitch of the vehicle is aligned with a portion of the towable body to which the trailer hitch is couplable; and
after the trailer hitch is aligned with the portion of the towable body, cause the suspension system to deliver air to the rear air compartment to raise the rear portion of the vehicle.

13. The vehicle of claim 12, wherein the programmable circuitry is to at least one of instantiate or execute the machine readable instructions to determine that the trailer hitch is coupled to the portion of the towable body when a trailer jack connected to the towable body is raised off a surface after the suspension system delivers air to the rear air compartment.

14. The vehicle of claim 13, wherein the programmable circuitry is to at least one of instantiate or execute the machine readable instructions to:
cause the suspension system to level the vehicle in response to determining that the trailer hitch is coupled to the portion of the towable body; and
cause the suspension system to remove air from the rear air compartment to lower the rear portion of the vehicle in response to determining that the trailer hitch is not coupled to the portion of the towable body.

15. A method comprising:
causing a suspension system to position a front of a vehicle in a raised position;
causing the suspension system to position a rear of the vehicle in a lowered position, the front in the raised position and the rear in the lowered position to slant the vehicle to facilitate loading or unloading the vehicle; and
preventing the vehicle from driving at a speed that satisfies a threshold when the front is in the raised position and the rear is in the lowered position.

16. The method of claim 15, wherein the threshold is 0 miles per hour.

17. The method of claim 15, wherein the threshold is 10 miles per hour.

18. The method of claim 15, wherein the raised position corresponds with approximately a maximum height associated with the suspension system, and wherein the lowered position corresponds with approximately a minimum height associated with the suspension system.

19. The method of claim 15, further including causing the suspension system to level the vehicle in response to the vehicle driving at the speed or that satisfies the threshold.

20. The method of claim 15, further including:
determining whether a trailer hitch of the vehicle is aligned with a coupler external to the vehicle; and
when the trailer hitch is aligned with the coupler, causing the suspension system to raise the rear of the vehicle.
